(19) United States
(12) Patent Application Publication
(10) Pub. No.: US 2007/0239074 A1
(43) Pub. Date: Oct. 11, 2007

(54) Line focusing acoustic wave source

(76) Inventor: Moshe Ein-Gal, Ramat Hasharon (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 11/354,053

(22) Filed: Feb. 15, 2006

(51) Int. Cl. A61H 1/00

(52) U.S. Cl. 601/2

(57) ABSTRACT

Method and apparatus for generating acoustic waves is described, including a plurality of acoustic wave source segments and associated line focusing segments capable of being distributed in a multiplicity of arrangements enabling a variety of line focus regions.

### FIELD OF THE INVENTION

The present invention relates generally to generation and focusing of acoustic waves, and specifically to generation and focusing of acoustic waves with electromagnetic energy.

### BACKGROUND OF THE INVENTION

Focused acoustic waves (or shockwaves, the terms being used interchangeably throughout) are being used increasingly in medical applications. For example, acoustic waves are used for tissue ablation, diagnostic imaging, drug delivery, breaking up concretions in the body such as kidney stones, treating orthopedic diseases, combating soft tissue complaints and pain, and other therapies which employ heat, cavitation, shock waves, and other thermal and/or mechanical effects for therapeutic purposes.

Prior art acoustic wave generation and focusing devices for use in therapeutic and remedial treatment have primarily been developed for therapy wherein the principal requirement to be met is that an optimal amount of energy be delivered to a small focal region at the vicinity of a focal point (“spot focus”).

The prior art typically converts electrical energy into acoustic waves, such as by generating a strong pulse of an electric or magnetic field, usually by capacitor discharge, converting the electromagnetic field into acoustic energy, and directing the energy to a small target by means of an associated focusing apparatus.

The prior art may be classified according to the geometry of the acoustic wave generation and associated focusing: point source and ellipsoidal reflector, planar source and acoustic lens, cylindrical source and parabolic reflector, and spherical source with no additional focusing, and a truncated conical source with parabolic reflector.

Point sources for the generation of acoustic waves in a lithotripter are described in various patents, such as U.S. Pat. Nos. 3,942,531 to Hoff et al. and 4,539,989 to Forsemann et al., for example. A planar source for generation of acoustic waves is described, for example, in U.S. Pat. No. 4,674,505 to Pauli et al.

Cylindrical sources for generation of acoustic waves are described, for example, in U.S. Pat. Nos. 5,058,569 to Hassler et al. and 5,174,280 to Gruenwald et al. Spherical sources are also mentioned in the background of U.S. Pat. No. 5,174,280.

A truncated conical acoustic wave source is described in U.S. Pat. No. 6,869,407 to Ein-Gal, the disclosure of which is incorporated herein by reference.

These prior art references disclose devices for spot focusing. There are therapeutic and remedial applications where concentration of acoustic energy within a focal region at the vicinity of a line, rather than within a small and limited focal zone, may be effective. For example, it is known that a decrease in bone material density (BMD) may result in osteoporosis and an increased risk of fracture. Reduction in BMD can be caused by a number of factors, the most common of which is the lack of normal physical activity. Thus, people who are engaged primarily in sedentary activities and confined and elderly persons are potential sufferers of the effects of reduced BMD. Additionally, women after the onset of menopause may exhibit a marked decrease in BMD.

Various treatments are employed to offset the reduction of BMD. These include drugs such as biophosphonates, calcitonin, and, particularly for women, estrogen replacement drugs. Certain types of exercises are recommended; thus, for example, although swimming is a good exercise for cardiovascular fitness, walking or jogging will provide better bone health. This is because they involve higher impact upon the bones, and it has been shown that pressure on bones has a positive effect on BMD. Accordingly, repeated application of acoustic pressure pulses on the length of a bone can trigger the physiological processes by which BMD is increased and the bone is strengthened.

U.S. Pat. No. 4,938,216 to Lele describes a line focusing apparatus in which a piezoelectric transducer is utilized to produce a beam of acoustic energy and a lens is used to focus the beam. U.S. Pat. No. 4,187,557 to Jones describes an elongated transducer having a spherically concave active face having a fan shaped directional characteristic. U.S. Pat. No. 4,258,474 to Hildebrand, et al. describes an elongated source of acoustic waves for high speed image scanning including mechanical translation capability.

### SUMMARY OF THE INVENTION

It is an object of some aspects of the present invention to provide an improved and operatively versatile device for acoustic energy deposition in a linear focal region.

It is a further object of some aspects of the present invention to provide a device for applying acoustic pressure in body tissue for therapeutic purposes such as activating the physiological processes that result in increased BMD.

It is yet a further object of some aspects of the present invention to provide an apparatus for acoustic energy deposition in body tissue for therapeutic purposes that will reduce undesired side effects such as heat, cavitation, or other thermal/mechanical effects or damage in non-target areas.

It is still a further object of some aspects of the present invention to provide an improved apparatus for energy deposition in body tissue that will reduce patient discomfort.

In some embodiments of the present invention, apparatus for generating and focusing acoustic energy on a linear focal region includes individual source-segments in which each source-segment is adapted to produce and focus acoustic waves onto an incremental line-focus segment. In some embodiments of the present invention, the source-segments may be discrete or a plurality of source-segments arranged in a multiple array that forms a continuous surface. The source-segments generate and focus acoustic waves onto a finite length line focus consisting of the associated line-focus segments.

In some embodiments of the present invention, the source includes a multiplicity of identical discrete source-segments arranged in a manner to produce and focus acoustic energy onto line-focus segments forming a line-focus of finite length.

In some embodiments of the present invention, the source-segment includes a planar transducer that generates planar acoustic waves in the direction of a cylindrical acoustic lens that focuses the waves onto a line-focus segment.

In some embodiments of the present invention, the planar transducer source element is a planar conducting membrane and an adjacent coil. Pulses of electrical energy are delivered into the coil and the associated rapid changes in the magnetic field induce currents in the membrane, turning it into a magnet with a polarization opposite to that of the coil. The ensuing repulsion of the membrane generates acoustic waves.

In some embodiments of the present invention, the identical source elements include a partially cylindrical transducer adapted to generate acoustic waves that propagate towards the central axis of the cylinder, thus focusing the waves onto a line-segment of the target.

In some embodiments of the present invention, the transducer includes a partially cylindrical conducting membrane that produces acoustic waves by electromagnetically interacting with electric pulses in an adjacent coil.

In some embodiments of the present invention, the device may be adapted to specific patient requirements by programming the operation of single discrete source-segments and clusters of discrete source-segments.

### BRIEF DESCRIPTION OF THE DRAWINGS

The present invention will be more fully understood from the following detailed description of embodiments thereof, taken together with the drawings, in which:

FIG. 1A is a simplified pictorial illustration of a discrete source-segment operative in accordance with an embodiment of the invention;

FIG. 1B is a simplified pictorial illustration of a linear line focus of finite length composed of individual line-focus segments:

FIG. 2A is a simplified pictorial illustration of a multiplicity of discrete source-elements arranged in accordance with an embodiment of the invention;

FIG. 2B is a simplified pictorial illustration of the source-element arrangement shown in FIG. 2A as seen from a plane parallel to the plane of the arrangement;

FIG. 3A is a simplified pictorial illustration of a linear array of discrete source-elements arranged to form a continuous surface in accordance with an embodiment of the invention;

FIG. 3B is a simplified pictorial illustration of an arrangement of discrete source-elements arranged individually in accordance with an embodiment of the invention;

FIG. 4 is a simplified pictorial illustration of a discrete source-segment composed of a planar transducer and partially cylindrical lens in accordance with an embodiment of the invention;

FIG. 5 is a simplified pictorial illustration of a planar transducer element composed of a conducting membrane and a coil array in accordance with an embodiment of the invention;

FIG. 6 is a simplified pictorial illustration of a discrete source-element composed of a partially cylindrical transducer;

FIG. 7 is a simplified pictorial illustration of a partially cylindrical transducer composed of a conducting membrane and a coil array in accordance with an embodiment of the invention; and

FIG. 8 is a simplified pictorial illustration of a patient receiving therapeutic treatment by an acoustic source device described in embodiments of the invention.

### DETAILED DESCRIPTION OF EMBODIMENTS

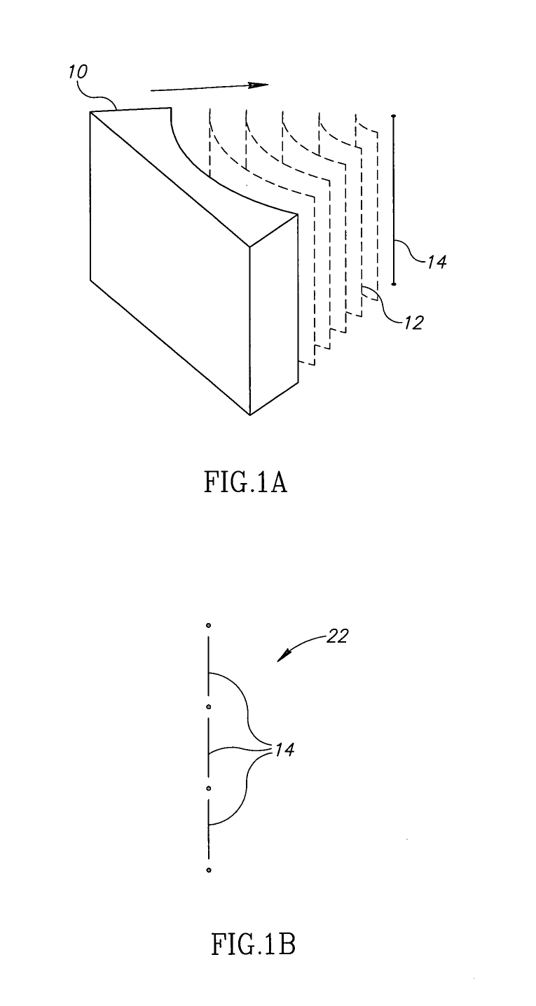

Reference is now made to FIG. 1A which illustrates a discrete source-segment 10 constructed and operative in accordance with an embodiment of the invention.

In the illustrated embodiment, discrete source segment 10 generates and focuses acoustic waves 12 that propagate in the direction of line-focus segment 14.

Reference is now made to FIG. 1B which shows a finite linear line focus 22 comprised of a series of line-focus segments 14. A line-segment focused wave can be produced in a way similar to known 3D techniques, but implemented only in two dimensions. For example, a plurality of point sources may be arranged along a line, each point source cooperating with an ellipsoidal reflector to focus the energy at the other focus of the ellipsoidal reflector. Since the point sources are arranged along a line, the resultant energy is focused on a line-focus segment. Another example is a line source (e.g., a piezoelectric line source) which generates waves along a line that are focused with an acoustic lens. The same line source may be focused with a parabolic reflector to a line focus. Yet another example is a plurality of directional point sources arranged along a line that emit waves to a line focus.

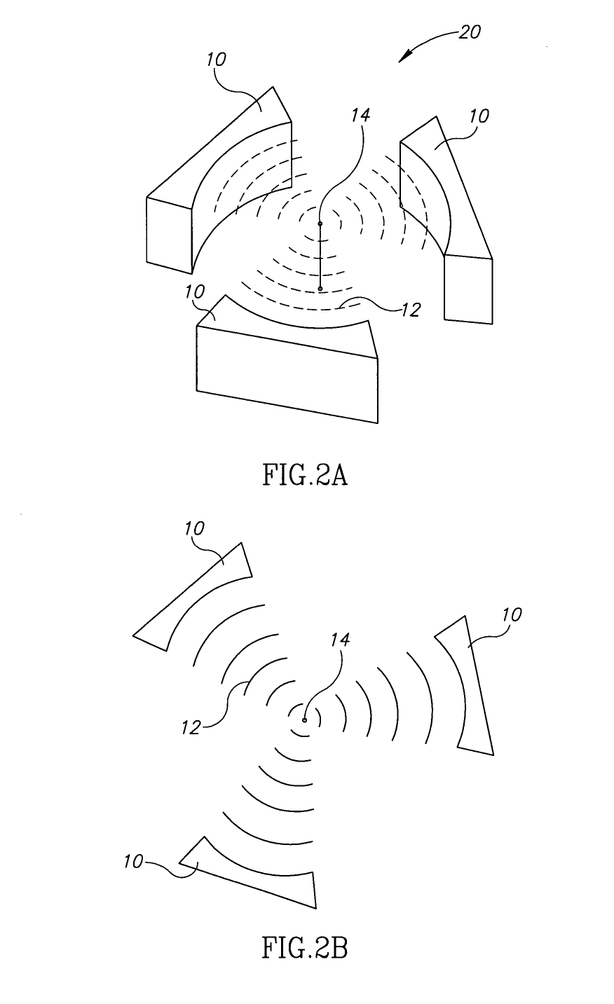

Reference is now made to FIG. 2A which shows an coplanar arrangement 20 of discrete source-segments 10 such that waves 12 generated by the individual source-segments 10 propagate toward line-focus segment 14 in accordance with an embodiment of the invention.

Reference is now made to FIG. 2B which shows the same coplanar arrangement 20 of discrete source-elements 10 as shown in FIG. 2A as seen from a plane parallel to the plane of coplanar arrangement 20.

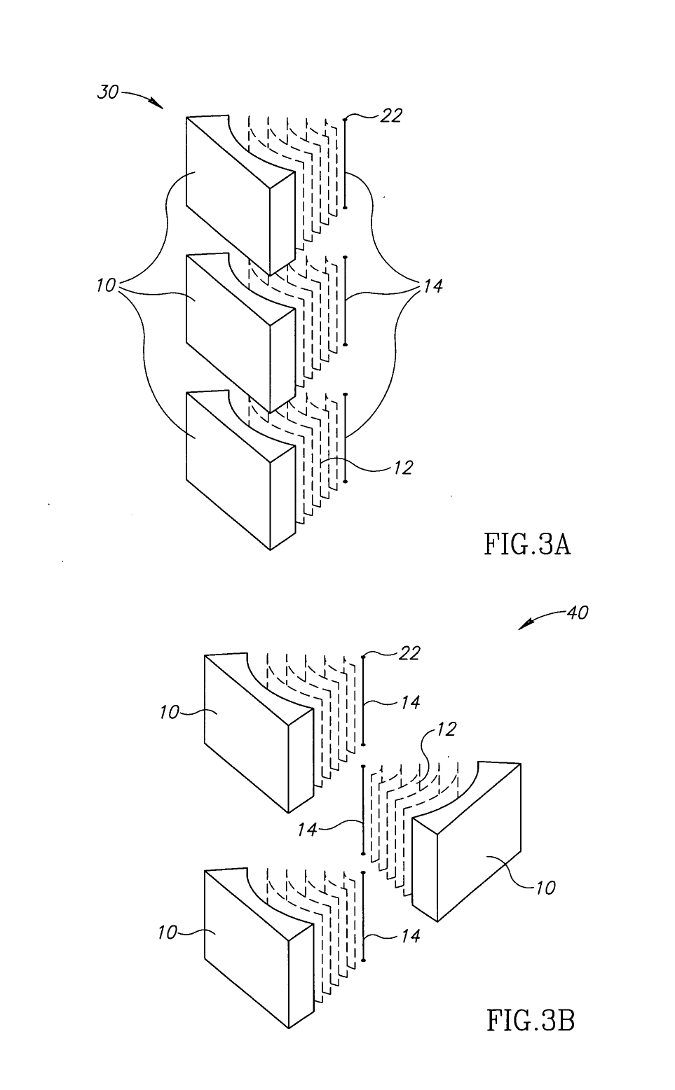

Reference is now made to FIG. 3A which shows a linear array 30 of discrete source-elements 10 arranged to form a continuous surface in accordance with an embodiment of the invention. Each discrete source-element 10 focuses acoustic waves 12 upon a line-focus segment 14 thus forming finite linear line focus 22.

Reference is now made to FIG. 3B which shows another arrangement 40 in accordance with an embodiment of the invention, in which a multiplicity of source-elements 10 are distributed on different planes and at different rotational locations around a rotation axis which is coterminous with finite linear line focus 22 composed of discrete line-focus segments 14.

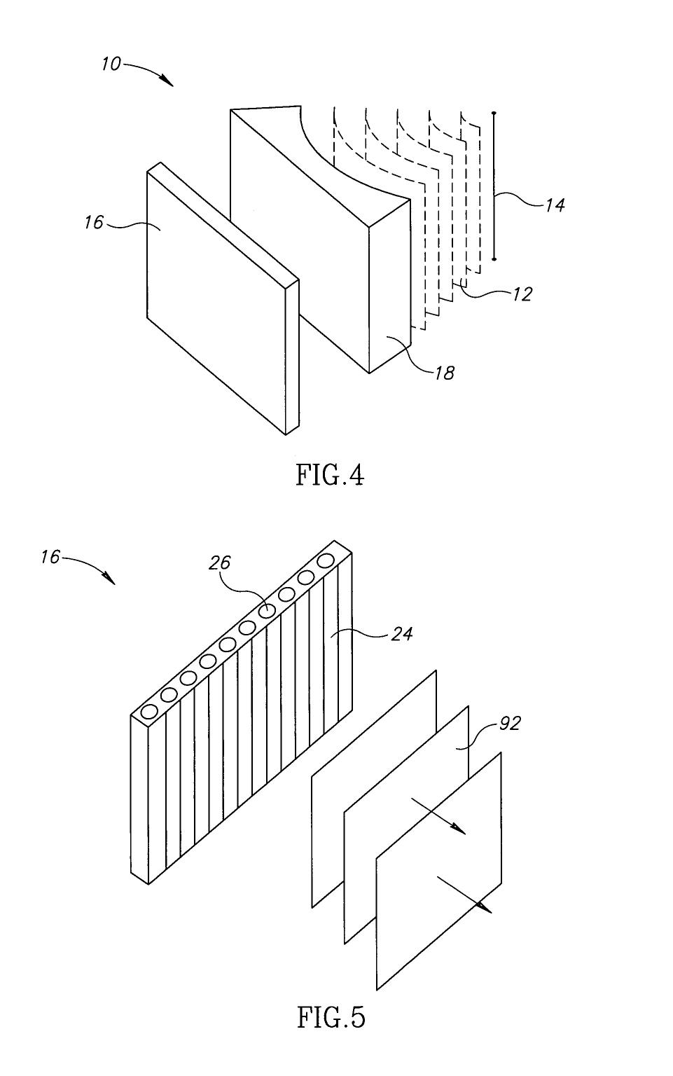

Reference is now made to FIG. 4 which illustrates a source segment 10 composed of a planar transducer 16 and partial cylindrical lens 18 that generates and focuses acoustic waves 12 in the direction of line-focus segment 14 in accordance with an embodiment of the invention.

Reference is now made to FIG. 5 which illustrates planar transducer 16 as shown in FIG. 4 which includes a planar electrically conducting membrane 24 that interacts electromagnetically with current pulses in adjacent coils 26 to produce planar waves 42 that propagate in the direction of partial cylindrical lens 18 shown in FIG. 4 in accordance with an embodiment of the invention.

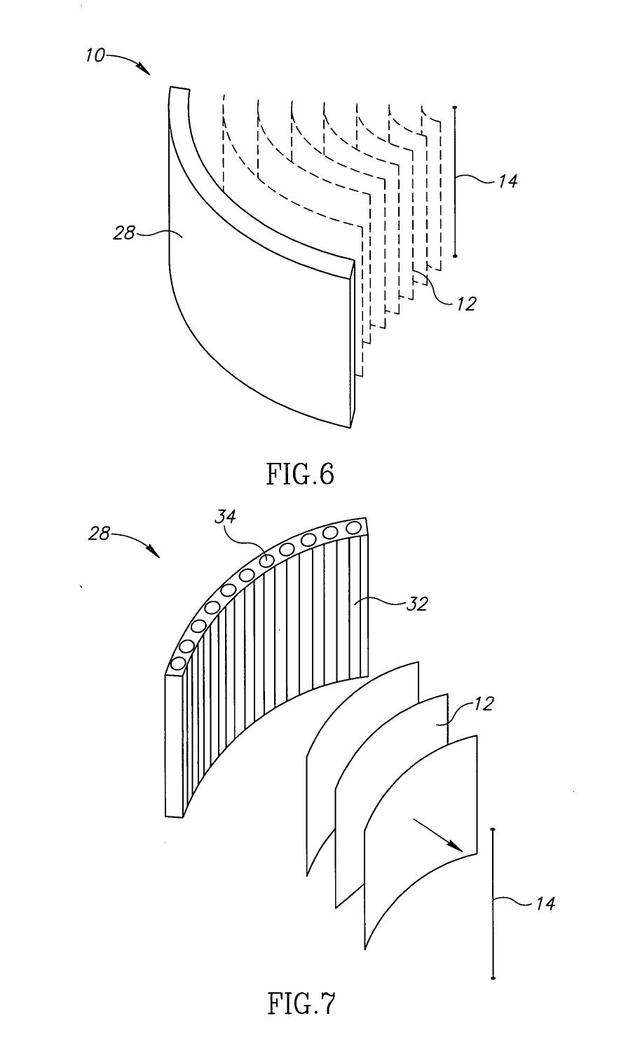

Reference is now made to FIG. 6 which illustrates discrete source element 10 which includes a partially cylindrical transducer 28 that generates acoustic waves 12 toward line-focus segment 14 in accordance with an embodiment of the invention.

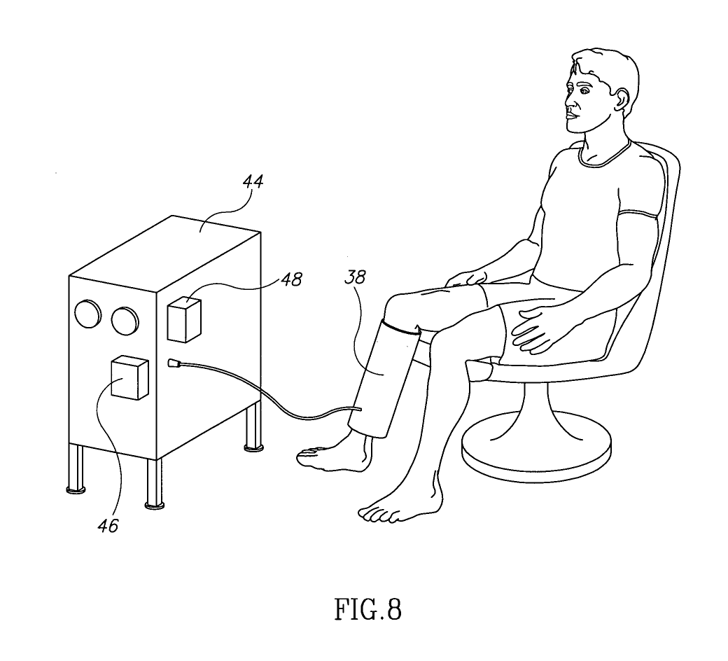

Reference is now made to FIG. 7 which illustrates an embodiment of the present invention in which partially cylindrical transducer 28 includes electrically conducting membrane 32 that interacts electromagnetically with current pulses in adjacent coils 34 to produce acoustic waves 12 propagating in the direction of line-focus 14.

Reference is now made to FIG. 8 which illustrates a patient 36 receiving therapeutic treatment by an acoustic source device 38 described in embodiments of the invention. By way of example and not limitation, patient 36 is shown undergoing therapeutic treatment in the region of the leg (such as applying acoustic pressure to the tibia and fibula).

Acoustic source device 38 contains single or multiple configurations of discrete source-segments 10 and line-focus segments 14 in accordance with some non-limiting embodiments of this invention. Operation and programming of acoustic source device 38 is accomplished by controller 44 which may include a source-element actuation device 46, the operation of which is controlled by system computer 48.

In some embodiments of the invention, system computer 48 may be programmed to vary the sequence of activation signals sent by source element actuation device 46 to discrete source segments 10 so as to vary the length of finite linear line focus 22 formed by line-focus segments 14 within acoustic source device 38. Alternatively and additionally, in some embodiments of the invention, system computer 48 may be programmed to vary the amplitude of acoustic waves generated by discrete source segments 10 within acoustic source device 38 so as to vary the pressure to which a linear target coterminous with finite linear line focus 22 is subject. By way of example and not limitation, the linear array of source-elements 10 shown in FIG. 3A can be activated singly or in multiples such that the generated acoustic wave energy is distributed over discrete segments or over the entire length of finite linear line focus 22. Thus, for example, the treatment of the patient can be tailored to meet the specific therapeutic needs.

Although some embodiments of the invention are described hereinabove with reference to treatment of BMD deficiencies, it will be appreciated that the principles of the present invention may be applied to other types of treatment and therapy.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

What is claimed is:

1. An apparatus for generating and focusing acoustic waves onto a finite linear focal zone comprising:
a plurality of acoustic wave source segments, wherein each of said segments is adapted to generate and focus acoustic waves on an incremental line-focus segment; and
a control unit adapted to actuate one or more of said acoustic wave source segments thereby forming a linear line-focus region of finite length.

2. The apparatus according to claim 1, wherein each of said acoustic wave source segments comprises an acoustic wave transducer and an acoustic lens, said acoustic wave transducer being operative to generate acoustic waves that propagate towards said acoustic lens, and said acoustic lens being adapted to focus said acoustic waves on the incremental line-focus segment.

3. The apparatus according to claim 1, wherein the incremental line-focus segments form a continuous incremental line-focus segment.

4. The apparatus according to claim 1, wherein each of said acoustic wave source segments comprises an acoustic wave transducer, and further an acoustic lens common to said acoustic wave source segments, said acoustic wave transducer being operative to generate acoustic waves that propagate towards said acoustic lens, and said acoustic lens being adapted to focus said acoustic waves on a continuous incremental line-focus segment.

5. The apparatus according to claim 2, wherein said acoustic wave transducer comprises a planar electrically conducting membrane adapted to electromagnetically interact with current pulses in an adjacent coil to produce planar acoustic waves.

6. The apparatus according to claim 1, wherein said acoustic wave source segment comprises an at least partially cylindrical transducer adapted to generate acoustic waves that propagate towards a central axis of said at least partially cylindrical transducer.

7. The apparatus of claim 6, wherein said at least partially cylindrical transducer comprises an at least partially cylindrical conducting membrane adapted to repel and produce acoustic waves by electromagnetically interacting with current pulses in an adjacent coil.

8. The apparatus according to claim 1, wherein the acoustic wave source segments are identical.

9. The apparatus according to claim 1 wherein said acoustic wave source segments are juxtaposed to one another to form a continuous surface.

10. A method for generating and focusing acoustic waves onto a finite linear focal zone comprising:
providing a plurality of acoustic wave sources, each of which is adapted to generate and focus acoustic waves on an incremental line-focus segment;
actuating said discrete acoustic wave sources to generate said acoustic waves; and
forming a finite linear focus region by combining said incremental line-focus segments.

11. The method according to claim 9, wherein said acoustic wave sources comprise acoustic wave generating transducers and focusing lenses.
